(19) United States
(12) Patent Application Publication
(10) Pub. No.: US 2009/0187659 A1
(43) Pub. Date: Jul. 23, 2009

(54) WIRELESS CONTENT DISTRIBUTION AND ADVERTISING

(75) Inventor: Rodolphe SAVOURE, Le Rouret (FR)

Correspondence Address: LAW OFFICES OF WILLIAM H. HOLT, 12311 HARBOR DRIVE, WOODBRIDGE, VA, 22192, US

(73) Assignee: TRUSTIVE B.V., Amsterdam (NL)

(21) Appl. No.: 12/270,754

(22) Filed: Nov. 13, 2008

(30) Foreign Application Priority Data
Nov. 13, 2007 (GB) 07 22261.5

(51) Int. Cl. G06F 15/173

(52) U.S. Cl. 709/226

(57) ABSTRACT

A method, system and software enable location- and profile-based display material to be aggregated and distributed to a mobile wireless device, on which a wireless connection manager application is installed, while roaming on any wireless IP network. This involves the steps of: identifying the connected user; locating the currently connected network geographically; using user preferences and location to select at least one provider and to filter display material from each provider; using hotspot capacity limitation information to filter out any display material not matching delivery bandwidth requirements; aggregating the display materials to be updated on the mobile wireless device; and retrieving display material directly from the selected providers to ensure up-to-date display material.

The present invention relates to the field of mobile wireless network connectivity in a roaming context. More specifically it relates to software connectivity components and content distribution systems allowing the distribution of digital content and advertising to connected users.

### BACKGROUND OF THE INVENTION

In today's context of extensive worldwide wireless network connectivity, service providers need to be able to constantly find new revenue streams by enriching their offers with value added content following subscriber's habits and preferences. The huge amount of information and digital content (music, video, news . . . ) available today on the Internet needs to be organized and classified for targeted delivery offering a user the possibility of choosing his interests and creating a centralized profile to be used according to his location and connection capacity, whether travelling or at home.

It is often not possible to access certain type of content (such as high quality movies) when connected to a wireless access point (Hotspot or Hotzone), as the access point does not provide enough bandwidth.

In addition to customized content delivery, service providers need to monetize their subscriber base by offering targeted advertisement (profile and location based) to their business partners. In order to raise the value of an advertisement campaign, the service provider should now be able to distribute advertisements based on the users' preferences, hence delivering the commercial message with a much greater impact.

Moreover, the possibility to deliver location based advertising in conjunction with users' preferences brings an additional value as the message is now related to the current location of the connected user (e.g. a restaurant promotion may be displayed when connecting to a wireless access point within a 2 km radius of the restaurant's location, knowing that the user is a gourmet according to his profile).

Due to the large coverage of wireless local area networks (WLAN) owned by many different operators of various sizes, it is not possible today to aggregate in a centralised and efficient manner all this information and to offer a global service that takes advantage firstly of service providers' large subscriber bases enriched with profile information, and secondly of a large aggregated wireless access network with in-depth knowledge of each access point's geographic location, type and network bandwidth capacity.

### SUMMARY OF THE INVENTION

In order to offer service providers the capability to deliver value-added aggregated content together with targeted and location based advertising to their existing customers, the invention provides a wireless connection manager application, featuring dynamic advertisement banners and embedding an HTML content portal, and linked to a powerful back office content distribution/aggregation server.

This invention uses connectivity information such as wireless access point geographic location, type and capacity together with the connected user's profile, in order to deliver selected digital content with targeted advertisement messages to the user, based on the information.

This invention is targeted to service providers and virtual wireless operators, and offers to their subscribers the ability to access their preferred content whenever they connect to a wireless access point.

The invention enables service providers to offer more aggregated value-added content to their subscribers, but also to benefit from a higher subscriber value when selling advertisement space to business partners due to the possibility of offering location-based and profile-based advertising campaigns.

Hence the invention provides a method for wireless aggregated content distribution and targeted advertising with these features; it provides software for performing this method; and it provides a system that combines such software with a wireless ISP aggregator network. It should be appreciated that the invention is not dependent upon a particular protocol for communicating information between a mobile device and a wireless network; for example it would be applicable to both a wi-fi network (based on the IEEE 802.11 standard) or to a WiMAX network (based on the IEEE 802.16 standard). The invention is thus applicable to any mobile device that communicates using either a wi-fi or a WiMAX network.

The invention also provides software for performing the method; this software may be supplied on a recording medium such as a CD, a memory card, or a memory stick, or may be downloaded from the internet.

Details of the solutions are provided in the accompanying drawings and in the detailed description which follows; these are given by way of example only.

### BRIEF DESCRIPTION OF THE DRAWINGS

For a clear understanding of the invention, drawings are provided to support the detailed description of the architecture, design and features. Included in the drawings are the following figures:

FIG. 1 is a network diagram illustrating the basic wireless session configuration (including a mobile wireless device, and a content distribution/aggregation server) showing the different domains with their main actors participating in the present invention;

FIG. 2 is a software block diagram showing the components of a wireless connection manager responsible for the implementation of the present invention as installed on a mobile wireless device of FIG. 1; internal communications between the components as well as external communications are depicted by arrows;

FIG. 3 is a software block diagram showing the components of the content distribution/aggregation server of FIG. 1 responsible for the implementation of the present invention; internal communications between the components as well as external communications with other key systems are depicted by arrows;

FIG. 4 is a software block diagram showing the components associated with the content distribution/aggregation server of FIG. 1 responsible for the user profile management (customisation); and

FIG. 5 is a software block diagram showing the components associated with the mobile wireless device of FIG. 1 responsible for the update of a local hotspots list.

### DETAILED DESCRIPTION

In general, the invention features a system providing selected aggregated digital content delivery to a mobile wireless device while roaming on any wireless network using connection information in conjunction with user preferences. The invention also offers the possibility of displaying targeted advertisements (multimedia banners) to the user based on the geographic location of the mobile wireless device after each successful connection. It is applicable to any mobile device that communicates with the Internet using either a wi-fi or a WiMAX network, or any other such packet-switched network. With such networks, unlike GSM/3G mobile phone networks, the mobile device is registered only to the central system and only when the user logs in, and the system does not know the location of the mobile device. Part of the present invention is the coding of the geographical locations of the network hotspots, that is to say the Wi-fi or WiMAX points of connection. The description will first present the scenario of the invention and then the process implementing the invention that will help understand the invention.

### Scenario

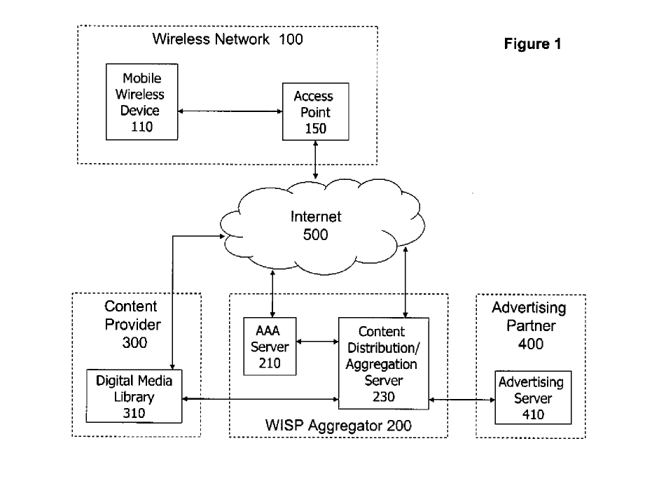

FIG. 1 presents the different actors taking part in the basic session of a user while roaming onto a wireless network 100, and explains the context of the invention by description of a typical scenario.

A roaming user equipped with a mobile wireless device 110, such as a lap-top computer or another portable or handheld device, is connected to the internet 500 through an access point 150 belonging to a visited wireless network 100. This access point 150 may be referred to as a hotspot. A standard authentication session is established between the access point 150 and an AAA server 210 of a WISP (wireless internet service provider) aggregator 200 in order to grant internet access to the mobile wireless device 110. (The AAA server 210 is a system that handles user requests for access to computer resources and provides an authentication, authorisation and accounting service.)

During this user authentication session, the user sends his credentials to the AAA server 210 that will then maintain all session parameters in its local database. These parameters include:
username
network identifier
hotspot unique identifier (network access server IP address)
session start time
   and will be used by a content distribution/aggregation server 230 to identify and geographically locate the connected user. Once the mobile wireless device 110 has access to the internet 500, it then sends a request to the content distribution/aggregation server 230 in order to update its digital content and corresponding advertisements banners. When the content distribution/aggregation server 230 receives this request identified by the username, it then checks the corresponding session parameters in the AAA server 210 local database and then performs the required tasks to build the answer to the request from the mobile wireless device 110. Based on the user profile and connected hotspot (visited wireless network 100) location, the content distribution/aggregation server 230 builds a dynamic HTML page from a digital media library 310 of a selected content provider 300 to be passed onto the mobile wireless device 110 in the form of a URL for display together with contextual advertisement banners retrieved from an advertising server 410 of a selected advertising partner 400.

Once the updated URL is received by the mobile wireless device 110, it is then displayed together with updated advertisement banners.

The present invention is offered by a WISP aggregator 200 and is installed on the roaming user's mobile wireless device 110. With the software of the invention installed on the mobile wireless device 110, the result is a dynamic graphical user interface update (content and advertisements) following the connection of the user to a wireless network 100. This update takes into account the user's preferences recorded in his profile, the geographical location of the wireless hotspot (the access point 150) and so of the user, as well as any potential change or location-based adjustment from the digital media library 310 (e.g. new relevant movie, up-to-date news) and the advertisement from the advertising server 410 (e.g. time limited promotion, special city offer on cinema).

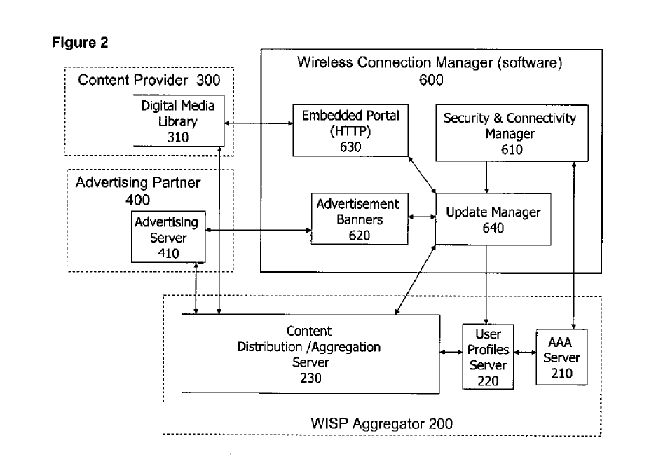

The following section describes in detail how the invention operates on the mobile wireless device 110 as described in FIG. 2.

### Process

FIG. 2 presents an embodiment of the invention in a wireless connection manager 600 application (i.e. software); this application would be provided by the WISP aggregator 200 and installed on the mobile wireless device 110. This drawing provides details of the internal components used for the invention, together with the data exchanged with external actors.

The wireless connection manager 600 is responsible for the connection to the wireless network 100, management of user credentials (username and password) and the local hotspots list 650 (part of the virtual network of the WISP aggregator 200) as well as updating the content of an embedded portal 630 and advertisement banners 620 upon each successful connection to any wireless network 100.

Upon each connection, a security & connectivity manager 610 of the connection manager 600 establishes communication with the wireless network 100 access point 150, ending in the AAA server 210 of the WISP aggregator 200 ensuring user authentication and authorisation for internet access. The AAA server 210 maintains all session parameters in its local database (username, network identifier, hotspot unique identifier, session start time . . . ).

Once the wireless connection manager 600 can reach the content distribution/aggregation server 230 of the WISP aggregator 200, the security and connectivity manager 610 requests an update of the embedded portal 630 and the advertisement banners 620 from the update manager 640. The latter forwards the request to the content distribution/aggregation server 230 of the WISP aggregator 200 which immediately requests a user profile 221 from a user profiles server 220. This request contains the username used for authentication provided as part of the update request coming from the update manager 640.

The content distribution/aggregation server 230 will then use this username in order to retrieve the corresponding session information from the AAA server 210 local database, and especially the hotspot unique identifier corresponding to the currently connected wireless network (this is only if the wireless network 100 is part of the WISP aggregator's virtual network).

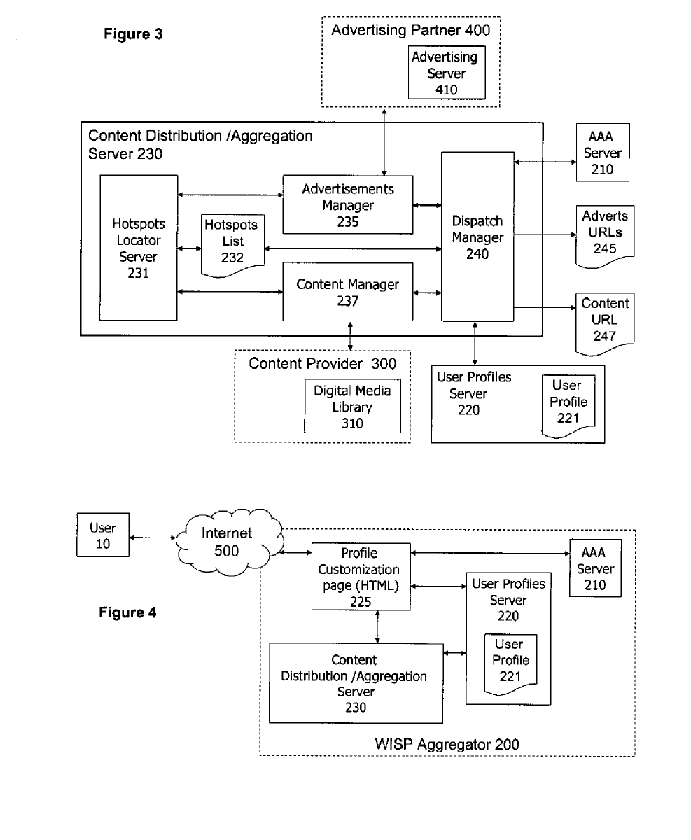

Referring also now to FIG. 3, a hotspots list 232 will then provide geo-codes (geographic position information) for each hotspot. Preferences retrieved from a corresponding user profile 221 together with hotspot geo-codes are then used to build a customized and aggregated dynamic HTML page that will be sent back to the update manager 640, and then forwarded to the embedded portal 630 for display.

When building the customized dynamic HTML page, the content distribution/aggregation server 230 communicates with the digital media library 310 of the selected content provider 300 to retrieve up-to-date matching content links. The content distribution/aggregation server 230 also communicates with the advertising server 410 of the selected advertising partner 400 to retrieve the corresponding advertisement banners 620 to be displayed in the wireless connection manager 600 according to user profile and geographic location.

The construction of updated URLs on the content distribution/aggregation server 230 is now explained in detail with reference to FIG. 3.

When receiving the request from the update manager 640 of the wireless connection manager 600, a dispatch manager 240 of the content distribution/aggregation server 230 retrieves the user profile 221 from the user profiles server 220 using the username sent as part of the request. It also retrieves the associated connection parameters from the AAA server 210, in particular the hotspot unique identifier.

The dispatch manager 240 will now try to match the hotspot unique identifier with the hotspots list 232 managed by a hotspots locator server 231. The role of the hotspots locator server 231 is to maintain the hotspots list 232 by cleaning, enriching, geo-coding and constantly updating the data received from wireless network providers constituting the virtual wireless network of the WISP aggregator 200.

Two cases are now possible:
Case 1, the hotspot unique identifier matches a hotspot in the hotspots list 232.

The dispatch manager 240 is now aware of the exact geographical location of the connected network 100 and can then use it when requesting the updated information from an advertisement manager 235 and a content manager 237.
Case 2, the hotspot unique identifier does not match any hotspot in the hotspots list 232.

The dispatch manager 240 will not use any geographical information when requesting the updated information from the advertisement manager 235 and the content manager 237.

The dispatch manager 240 now sends a request to the content manager 237, which will immediately check for updated content (enriched with user preferences, e.g. financial only) in the digital media library 310 of the selected content provider 300. The selection of the content provider 300 amongst a list of existing partners will be made by the content manager 237 according to the user preferences as recorded in its user profile 221 (e.g. News from CNN, News from AFP . . . ). The content manager 240 also takes into account the capacity of the actual connection (available bandwidth) as retrieved from the hotspots list 232 in order to remove some of the content that might not be able to be delivered (e.g. high quality video).

Once all content components have been retrieved and validated against the user profile 221 and currently connected hotspot parameters (geo-codes & connection capacity), the dynamic HTML page is built on the fly by the content manager 237 and stored locally. The new available HTML page is then referenced by a content URL 247 that is sent back to the dispatch manager 240 and then forwarded to the update manager 640 for display in the embedded portal 630. Some of the content on this HTML page makes direct reference to URLs hosted directly by the digital media library 310 in order to optimize network traffic and storage resources as well as guarantee latest up-to-date information to the user.

In parallel, the dispatch manager 240 sends a request to the advertising manager 235 that will immediately forward it to the selected advertising partners 400. The selection of the advertising partner 400 is made by the advertising manager 235 based on the user profile (e.g. interest in cars & cinema, preferred language . . . ) as well as the hotspot geographical location (e.g. Paris, France).

Once all matching advertisement banners have been retrieved or identified and validated against the user profile 221 and currently connected hotspot parameters (geo-codes & connection capacity) the URLs 245 of the new advertisements are sent back to the dispatch manager 240 and then forwarded to the update manager 640 which will force the advertisement banners 620 of the wireless connection manager 600 to refresh. Some of these URLs 245 are hosted directly by the advertising server 410 in order to optimize network traffic and storage resources as well as guarantee targeted up-to-date message delivery to the user.

After each successful connection the update manager 640 will send session statistics information to the user profile server 220 for analysis and usage pattern generation. This information will also be used to enrich the hotspots list 232 with information such as network capacity, availability, etc.

FIG. 4 shows how the user profile preferences are set.

In order for a user 10 to setup and maintain his user profile 221, the WISP aggregator 200 offers a profile customisation page 225 that will display a list of available content types from various content providers 300 (e.g. CNN, AFP, Yahoo, Google, You tube, Daily motion . . . ) and grouped by different categories (e.g. finance, news, cinema, cars . . . ). The list of available content is dynamically retrieved from the content distribution/aggregation server 230 in order to always be up-to-date.

The user 10 accesses the profile customisation page 225 through the internet 500. He then enters his credentials (username/password), which are checked by the AAA server 210, and then sets his preferences. Once the user 10 has set his preferences, they are saved in the user profile server 220 as a user profile 221 record for further use.

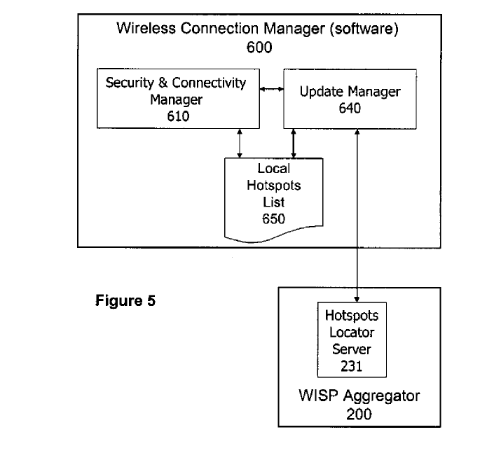

FIG. 5, to which reference is now made, depicts the update process for the local hotspots list 650, between the wireless connection manager 600 and the hotspots locator server 231 of the WISP aggregator 200. Upon each successful connection (maximum once per 24 hrs) of the wireless connection manager 600 to a network allowing access to the hotspots locator server 231 of the WISP aggregator 200, the security and connectivity manager 610 requests an update of the local hotspots list 650 from the update manager 640. The update manager 640 then communicates with the hotspots locator server 231 of the WISP aggregator 200 using a secured communication protocol (HTTPS) in order to verify if any hotspot has been added, modified or deleted from the hotspots list 232 of the content distribution/aggregation server 230. In the event that some changes have occurred since the last check, data is sent back from the hotspots locator server 231 to the update manager 640 over the internet 500, using encryption in order to prevent the information from being intercepted.

The hotspot changes are then received by the update manager 640 and then encrypted into the modified local hotspots list 650. The update manager 640 then notifies the security and connectivity manager 610 that the local hotspots list 650 has been updated, so this can be taken into account for the next session.

I claim:

1. A method for aggregating and distributing location and profile based display material to a mobile wireless device on which a wireless connection manager application is installed while roaming on any wireless IP network, the method comprising the steps of:
identifying the connected user with a unique username and password;
locating geographically the currently connected network by matching to a list of hotspots;
using user preferences and location to select at least one provider and to filter display material from each provider;
using hotspot capacity limitation information to filter out any display material not matching delivery bandwidth requirements;
aggregating the display materials to be updated on the mobile wireless device; and
retrieving display material directly from the selected providers to ensure up-to-date display material.

2. A method as claimed in claim 1 wherein the display material comprises targeted advertisements.

3. A method as claimed in claim 1 wherein the display material comprises non-advertising content, and the non-advertising content is aggregated into a single HTML page to be updated on an embedded portal of the mobile wireless device.

4. A method as claimed in claim 1 also including updating on a regular basis and in a secure manner all parameters used by the method.

5. Software for aggregating and distributing location and profile based display material to a mobile wireless device while roaming on any wireless IP network, the software being arranged to manage the steps of:
identifying the connected user;
locating geographically the currently connected network by matching to a list of hotspots;
using user preferences and location to select at least one provider and to filter display material from each provider;
using hotspot capacity limitation information to filter out any display material not matching delivery bandwidth requirements;
aggregating the display materials to be updated on the mobile wireless device; and
retrieving the display material directly from the selected providers to ensure it is up-to-date.

6. Software as claimed in claim 5 wherein the display material comprises targeted advertisements.

7. Software as claimed in claim 5 wherein the display material comprises non-advertising content, and is aggregated into a single dynamic HTML page to be updated on an embedded portal of the mobile wireless device.

8. Software as claimed in claim 5 also comprising means to update on a regular basis and in a secure manner all the requisite parameters.

9. Software for installation on a wireless mobile device to enable display material to be distributed to the mobile wireless device while roaming on any wireless IP network, the software comprising an update manager, a security and connectivity manager, and embedded means to display advertisement banners and to display HTTP screens.

10. A system for aggregating and distributing location and profile based display material to a mobile wireless device while roaming on any wireless IP network, the system comprising software installed on the mobile device as well as on a WISP aggregator server for managing the steps of:
identifying the connected user with his unique username and password;
locating geographically the currently connected network by matching to a list of hotspots;
using user preferences and location to select at least one provider and to filter the display material from the providers;
using hotspot capacity imitation information to filter out any display material not matching delivery bandwidth requirements;
aggregating the display materials to be updated on the mobile wireless device; and
retrieving the display material directly from the providers to ensure it is up-to-date.

11. A system as claimed in claim 10 wherein the display material comprises targeted advertisements.

12. A system as claimed in claim 10 wherein the display material comprises non-advertising content and is aggregated into a single dynamic HTML page to be updated on an embedded portal of the mobile wireless device.

13. A system as claimed in claim 10 also including updating on a regular basis and in a secure manner all parameters required during operation, by transmission of updating data between the mobile wireless device and the WISP aggregator server.
